(19) United States
(12) Patent Application Publication
(10) Pub. No.: US 2008/0209740 A1
(43) Pub. Date: Sep. 4, 2008

(54) Jack-Knife

(75) Inventors: Milan Kacavenda, Pieve Di Cadore (BL) (IT); Milenko Kacavenda, Pieve Di Cadore (BL) (IT)

Correspondence Address: Novak Druce + Quigg, LLP, 1300 Eye Street, NW, Suite 1000, Suite 1000, West Tower, Washington, DC, 20005, US

(73) Assignee: SKEYOTTICA DI KACAVENDA MILENKO, PIEVE DI CADORE (BL) (IT)

(21) Appl. No.: 11/569,849

(22) PCT Filed: Jun. 1, 2005
(86) PCT No.: PCT/IB2005/001537

§ 371 Date: Nov. 30, 2006

(30) Foreign Application Priority Data
Jun. 4, 2004 (IT) UD2004A000115

(51) Int. Cl. B26B 1/04

(52) U.S. Cl. 30/161

(57) ABSTRACT

A jack-knife including a blade and a handle, inside which there is a housing for the blade and with respect to which the blade is pivoted with one pivoting end. A safety device is disposed inside the handle, cooperates with the pivoting end of the blade and is able both to prevent an unwanted escape of the blade from the housing, and to clamp the blade when it is in a functioning position, that is, at least partly outside the handle.

### FIELD OF THE INVENTION

The present invention concerns a jack-knife comprising a handle and a blade, wherein the blade can be selectively removed or repositioned manually inside the handle.

### BACKGROUND OF THE INVENTION

A jack-knife is known, which comprises a handle, a blade, one end of which is contained in the handle and is pivoted thereon, and a spring-type device to drive the blade in order to selectively remove it from the handle and reposition it therein.

Said jack-knife has the disadvantage that it is dangerous for the safety of the user, since the drive device can be accidentally activated, for example causing an unwanted and unexpected movement of the blade.

Another disadvantage is that, if the blade is clamped before it reaches the functioning position, the spring of the drive device is no longer able to take the blade to the correct functioning position.

One purpose of the present invention is to achieve a jack-knife which can be used in safety by a user, preventing unwanted movements of the blade.

The Applicant has devised and embodied the present invention to overcome the shortcomings of the state of the art and to obtain other advantages.

### SUMMARY OF THE INVENTION

The present invention is set forth and characterized essentially in the main claim, while the dependent claims describe other innovative characteristics of the invention.

In accordance with this purpose, a jack-knife according to the present invention comprises a blade and handle means, inside which there is a housing for said blade and with respect to which the blade is pivoted at its pivoting end.

According to a characteristic of the present invention, the jack-knife comprises safety means which are able both to cooperate with said pivoting end of the blade, and also to prevent an unwanted escape of the blade form the housing when it is returned to its position of non-use, and also to clamp the blade when it is outside the handle and is in its functioning position.

According to a preferential embodiment, the safety means comprise a cam, which is made in a piece at the pivoting end of the blade and cooperates with clamping means by means of elastic means, contained inside the handle in proximity with the pivoting point of the blade.

The clamping means comprise, in the preferential embodiment, a shaped clamping bar having one long side and two short sides, parallel to each other and perpendicular to the long side, which are able to slide on two guides made on the handle.

The elastic means advantageously comprise at least two springs, each of which is disposed inside a relative guide in order to cooperate with a relative short side of said bar.

The cam comprises two shaped seatings, respectively a first shaped seating and a second shaped seating, respectively able to contain the clamping bar when the blade is inside the housing and when the blade is outside the handle, in the functioning position.

Thanks to the safety means described above, the jack-knife can be used by a user substantially without the danger of the blade escaping from its housing, or accidentally returning thereto without command. Moreover, the jack-knife according to the present invention has the following advantages:

the blade, even if it is clamped, once it has been released continues its travel until it reaches the functioning position, guaranteeing the operator that the blade will always be functioning;

the blade reaches the correct functioning position easily, thanks to the thrust that the bar, by means of the elastic means, actuates on the cam, so that the jack-knife opens quickly and becomes immediately usable.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a lateral view, partly in section, of the jack-knife according to the present invention in a first operating condition;

FIG. 2 is a section from II to II of the jack-knife in FIG. 1;

FIG. 3 is an enlarged view of a detail of FIG. 1;

FIG. 4 is a lateral view, partly in section, of the jack-knife in FIG. 1, in a second operating condition;

FIG. 5 is an enlarged view of a second detail of FIG. 1.

### DETAILED DESCRIPTION OF A PREFERENTIAL FORM OF EMBODIMENT

With reference to the attached drawings, a jack-knife 10 according to the present invention comprises a handle 11, a blade 12, pivoted with its pivoting end 12a inside the handle 11, and a safety device 13.

The handle 11 (FIG. 2) consists of two equal parts, respectively a first part 14 and a second part 15.

Each part 14 and 15 comprises a first outer plate 16 and a second inner plate 17, advantageously made of metal.

The two parts 14 and 15 are connected by means of two screws 18.

Two nuts 20 are screwed onto the screws 18 and interposed between the inner plates 17, so as to distance them and thus create a housing 21 for the blade 12. The latter is pivoted on the handle 11 by means of a removable pin 22.

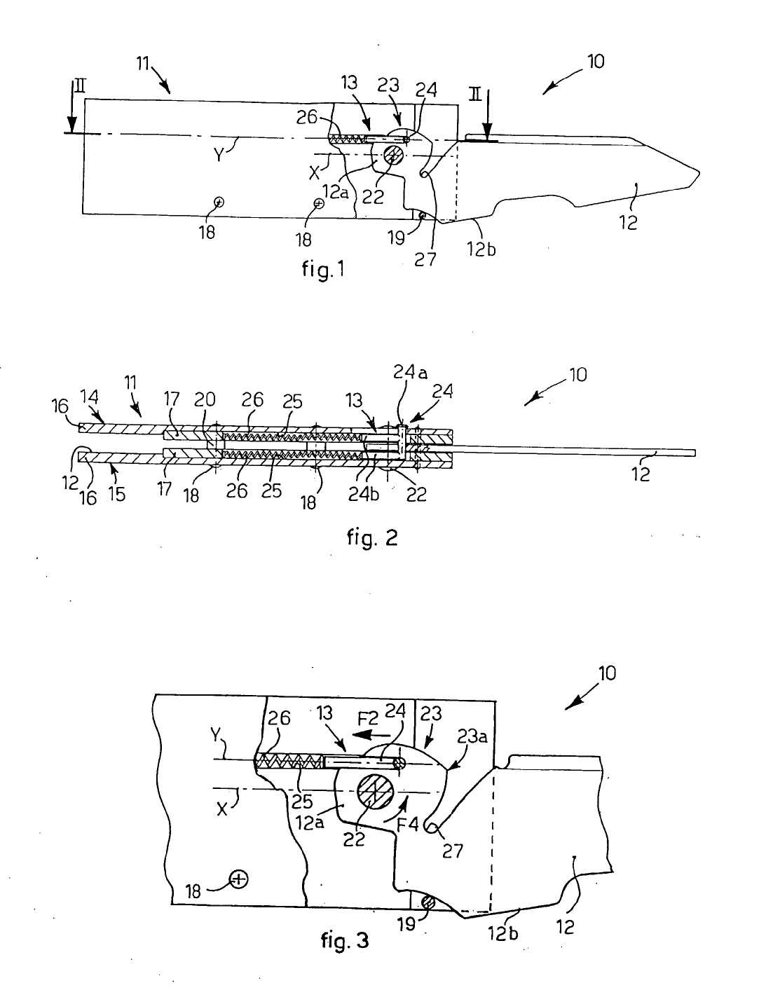

An end-of-travel pin 19 is assembled in an intermediate position between the parts 14 and 15 (bottom right in FIGS. 1, 3 and 4) and prevents the blade 12 from being moved downwards beyond its functioning position, substantially aligned with the handle 11.

The safety device 13 comprises a clamping bar 24, at least two springs 26 and a cam 23.

The clamping bar 24 (FIG. 2) comprises a long side 24a and two short sides 24b, parallel to each other and perpendicular to the long side 24a. The latter are able to slide on two guides 25, made on both the inner plates 17 and disposed in a misaligned position with respect to an axis X of the pin 22 (FIGS. 1, 3 and 4).

The springs 26 (FIG. 2) are disposed inside both the guides 25 and cooperate with the ends of the short sides 24b of the clamping bar 24, along an axis of movement Y.

The cam 23 (FIGS. 3, 4 and 5) is made in a piece on the pivoting end 12a of the blade 12 and two shaped seatings are obtained therein, respectively a first shaped seating 27 and a second shaped seating 28.

The first shaped seating 27 (FIG. 5) has a first working sector α and a second working sector β, joined together in a vertex 23a.

The safety device 13 prevents the blade 12 escaping from the housing 21 and clamps the blade 12 when it is in its functioning position, removed from the handle 11.

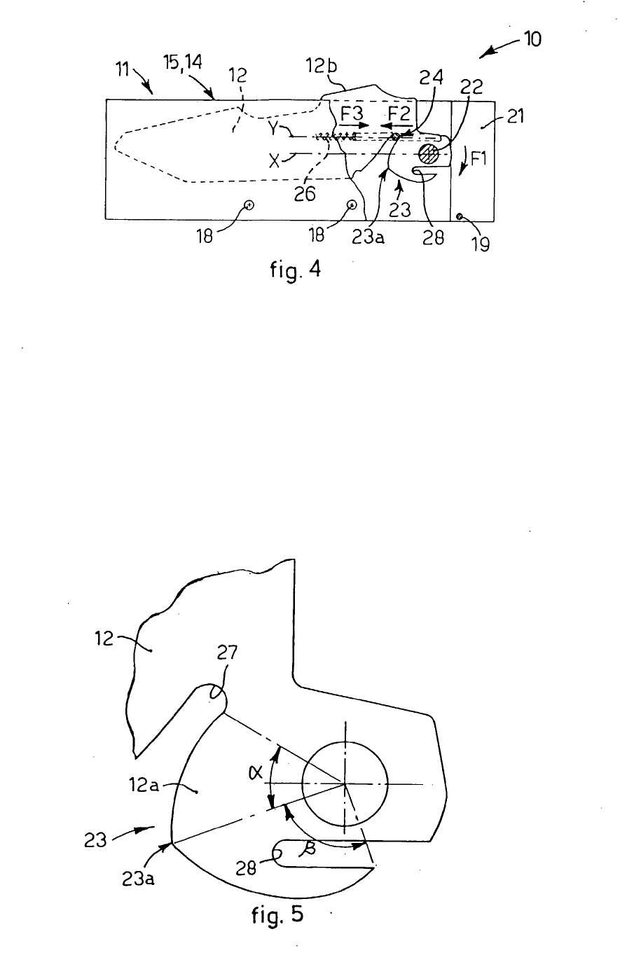

In the inactive position (FIG. 4), that is, when the blade 12 is inside the handle 21, the clamping bar 24 is positioned inside the first shaped seating 27.

The blade 12 is removed from the housing 21 by gripping manually a part 12b of the blade 12, protruding from the seating 21, and moving said blade 12 so as to make it rotate around the pin 22 in direction F1 (FIG. 4). Doing this, the cam 23 displaces the clamping bar 24 in direction F2, making it come out of the first shaped seating 27.

If the force applied manually to remove the blade 12 from the seating 21 is not enough to overcome the contrasting action exerted by the springs 26 on the bar 24 (direction F3), and to take the first working sector α, and hence the vertex 23a, beyond the axis of movement Y, then the clamping bar 24, thrust by the springs 26 in direction F3, applies on the cam 23 a force such as to return the blade 12 to the starting position, inside the housing 21.

Vice versa, if the force applied to remove the blade 12 from the housing 21 is able to overcome the contrasting force exerted by the springs 26 on the bar 24, then the blade 12 is easily taken to the functioning position (FIGS. 1, 2 and 3). As soon as the blade 12 is taken to the functioning position, then the bar 24, thrust by the springs 26, enters into the second shaped seating 28 and clamps the blade 12 in said position.

When the blade 12 is to be returned inside the housing 21 (FIG. 3), then the clamping bar 24 must be moved manually in direction F2, so as to make it come out from the second shaped seating 28 and thus unclamp the blade 12. At this point, the blade 12 is made to rotate manually in direction F4, so as to return it inside the housing 21.

It is clear, however, that modifications and/or additions of parts may be made to the knife 10 as described heretofore, without departing from the field and scope of the present invention.

It is also clear that, although the present invention has been described with reference to specific examples, a person of skill in the art shall certainly be able to achieve many other equivalent forms of jack-knife, all coming within the field of protection of the present invention.

1. A jack-knife comprising a blade and handle means, inside which there is a housing for said blade and with respect to which said blade is pivoted with one pivoting end, the jack-knife comprising safety means disposed inside said handle, cooperating with said pivoting end of said blade and able both to prevent an unwanted escape of said blade from said housing, and to clamp said blade when it is in the functioning position, at least partly outside said handle, wherein said safety means comprise a cam, made in a piece on said pivoting end of said blade, and clamping means cooperating with said cam by means of elastic means, and wherein said cam comprises a first shaped seating having a first working sector (α) and a second working sector (β) joined in a vertex, said first shaped seating being able to contain said clamping means when said blade is inside said housing.

2. (canceled)

3. The jack-knife as in claim 1, wherein said clamping means comprise a clamping bar, shaped and having a long side and two short sides, parallel to each other and perpendicular to said long side, each of said short sides being able to slide according to an axis of movement (Y) along a relative guide made on said handle, when the blade is taken from the position inside said housing to said functioning position, or vice versa.

4. The jack-knife as in claim 2, wherein said elastic means comprise at least two springs, each of them being disposed inside said guide and able to cooperate with one of said short sides of said bar.

5. (canceled)

6. The jack-knife as in claim 2, wherein said first working sector (α) is able to cooperate with said clamping bar by means of said elastic means, in order to prevent said blade from escaping from said housing, if a force is not applied manually thereon sufficient to take said first working sector (α), and hence said vertex, beyond said movement axis (Y) of said short sides along the guides.

7. The jack-knife as in claim 1, wherein said cam comprises a second shaped seating able to contain said clamping means, in order to clamp said blade when it is in said functioning position.

8. A jack-knife as in claim 1, wherein said clamping means is able to be moved manually in a direction (F2), in order to unclamp said blade from said functioning position.

9. The jack-knife as in claim 1, wherein said handle comprises two parts, respectively first part and second part, both comprising an outer plate and an inner plate.

10. The jack-knife as in claims 2 and 7, wherein said guides are made on said inner plates.

11. The jack-knife as in claim 7, wherein said parts are located at a determinate distance from each other, achieving said housing.
